(19) United States
(12) Patent Application Publication
(10) Pub. No.: US 2022/0237481 A1
(43) Pub. Date: Jul. 28, 2022

(54) VISUAL RECOGNITION TO EVALUATE AND PREDICT POLLINATION

(71) Applicant: INTERNATIONAL BUSINESS MACHINES CORPORATION, ARMONK, NY (US)

(72) Inventors: Steven Ware Jones, Astoria, NY (US); Jennifer A. Mallette, Vienna, VA (US); ZHENG XIE, Clontarf (IE); Lisa Beth Lurie, New York, NY (US)

(21) Appl. No.: 17/159,211

(22) Filed: Jan. 27, 2021

(51) Int. Cl. G06N 5/04; G06K 9/46; G06K 9/62; G06N 20/00

(52) U.S. Cl. CPC G06N 5/04; G06K 9/46; G06N 20/00; G06K 9/6256; G06K 9/6262

(57) ABSTRACT

The exemplary embodiments disclose a method, a computer program product, and a computer system for evaluating the pollination of one or more crops, the method comprising collecting pollination data, extracting one or more features from the collected data, and evaluating a current state of pollination of the one or more crops based on the extracted one or more features and one or more models.

### BACKGROUND

The exemplary embodiments relate generally to pollination, and more particularly to evaluating current pollination states and predicting future pollination states.

Many farmers rely on pollination to successfully grow crops, as successful pollination often results in successful crop output. Many farmers purchase or rent beehives from beekeepers to pollinate their crops and would benefit from knowing the current pollination state of their crops as well as predictions of future pollination success. For example, a farmer may benefit from knowing that their crops are under pollinated and that their crop output may increase with the addition of beehives.

### SUMMARY

The exemplary embodiments disclose a method, a computer program product, and a computer system for evaluating the pollination of one or more crops, the method comprising collecting pollination data, extracting one or more features from the collected data, and evaluating a current state of pollination of the one or more crops based on the extracted one or more features and one or more models.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a pollination prediction system 100, in accordance with the exemplary embodiments.

FIG. 2 depicts an exemplary flowchart illustrating the operations of a pollination predictor 134 of the pollination prediction system 100 in making a pollination evaluation and prediction, in accordance with the exemplary embodiments.

FIG. 3 depicts an exemplary block diagram depicting the hardware components of the pollination prediction system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Many farmers rely on pollination to successfully grow crops, as successful pollination often results in successful crop output. Many farmers purchase or rent beehives from beekeepers to pollinate their crops and would benefit from knowing the current pollination state of their crops as well as predictions of future pollination success. For example, a farmer may benefit from knowing that their crops are under pollinated and that their crop output may increase with the addition of beehives.

Exemplary embodiments are directed to a method, computer program product, and computer system for making pollination evaluations and predictions. In embodiments, machine learning may be used to create models capable of determining a current pollination state and predicting future pollination states, while feedback loops may improve upon such models. Moreover, data from user uploads, databases, or sensors 110 may be used to determine a current pollination state and future pollination state. A user may wish to know a current pollination state and future pollination states of their crops, plants, flowers, etc. for a number of purposes or reasons. For example, a user may wish to know if a region of their crops are sufficiently pollinated such that they can move beehives to a different region of their crops. In another example, a user may wish to know how many beehives are necessary to sufficiently pollinate 50 acres of crops within a certain time constraint. In general, it will be appreciated that embodiments described herein may relate to making pollination evaluations and predictions within any environment and for any motivation.

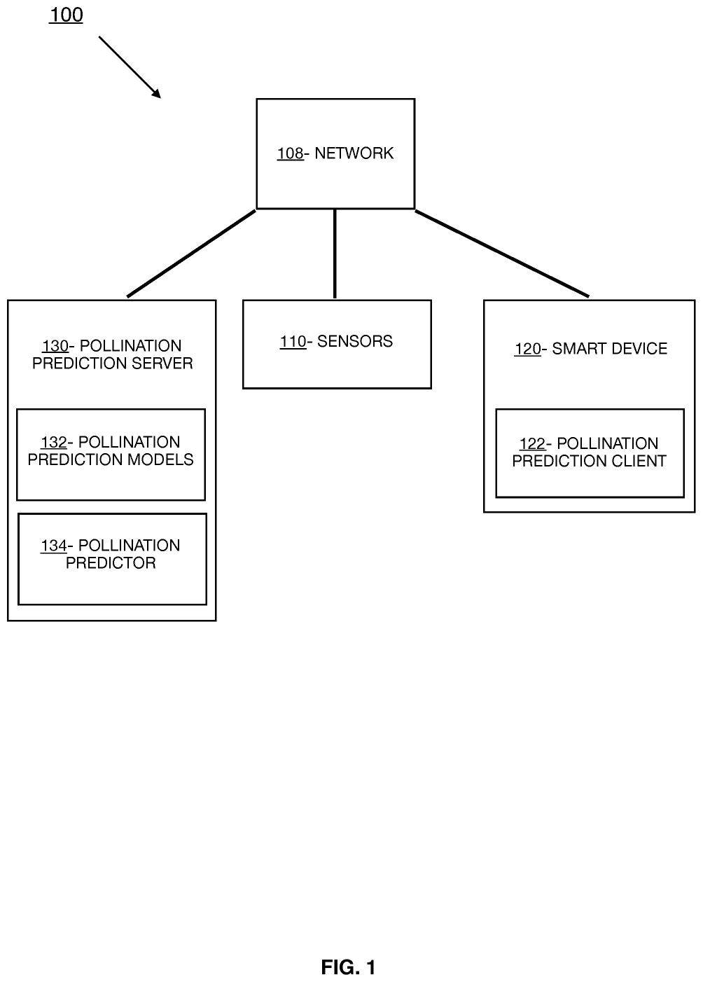

FIG. 1 depicts the pollination prediction system 100, in accordance with the exemplary embodiments. According to the exemplary embodiments, the pollination prediction system 100 may include a smart device 120, a pollination prediction server 130, and one or more sensors 110, which may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the pollination prediction system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

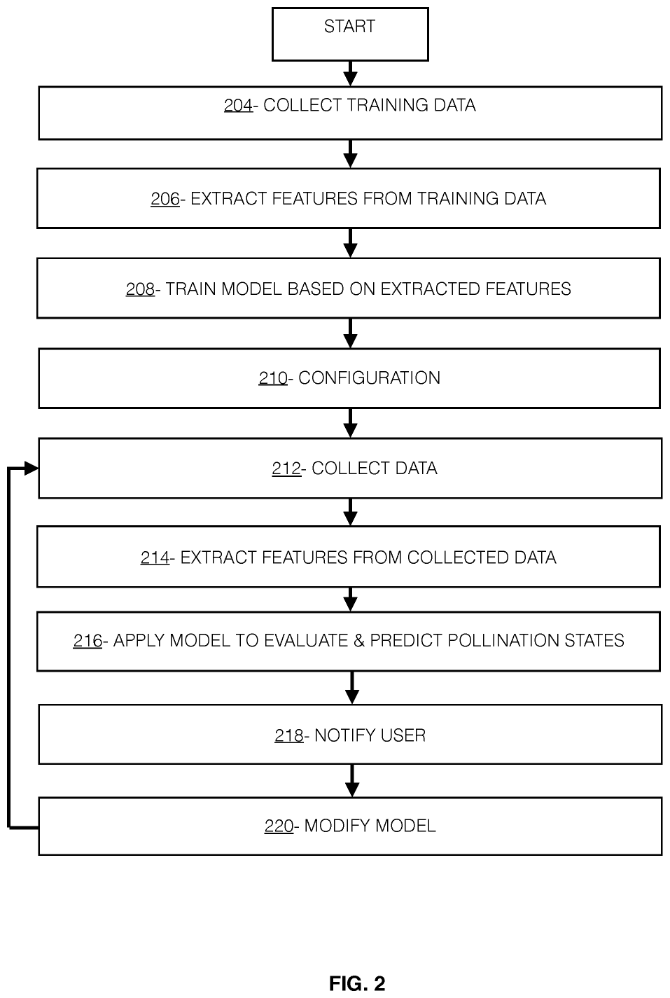

In example embodiments, the sensors 110 may be a camera, radiometer, photometer, light sensor, infrared sensor, movement detection sensor, pressure sensor, moisture sensor, or other sensory hardware/software equipment, and may incorporate radar and/or light detection and ranging (LiDAR). In embodiments, the sensors 110 may be integrated with and communicate directly with smart devices such as the smart device 120, e.g., smart phones and laptops. Although the sensors 110 are depicted as integrated with smart device 120, in embodiments, the sensors 110 may be external (i.e., standalone devices) connected to the smart device 120 or the network 108. In embodiments, the sensors 110 may be incorporated within an environment in which the pollination prediction system 100 is implemented. For example, in embodiments, the sensors 110 may be security cameras fastened to a light fixture in a field, video cameras fastened to devices or vehicles (land vehicles, water vehicles, aerial vehicles, etc.) traveling over a sub-region of land, etc., and may communicate via the network 108. The sensors 110 are described in greater detail with respect to FIG. 2-5.

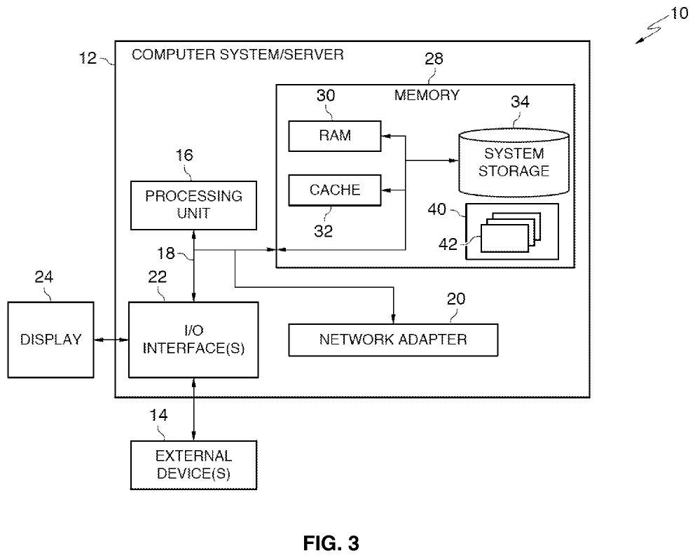

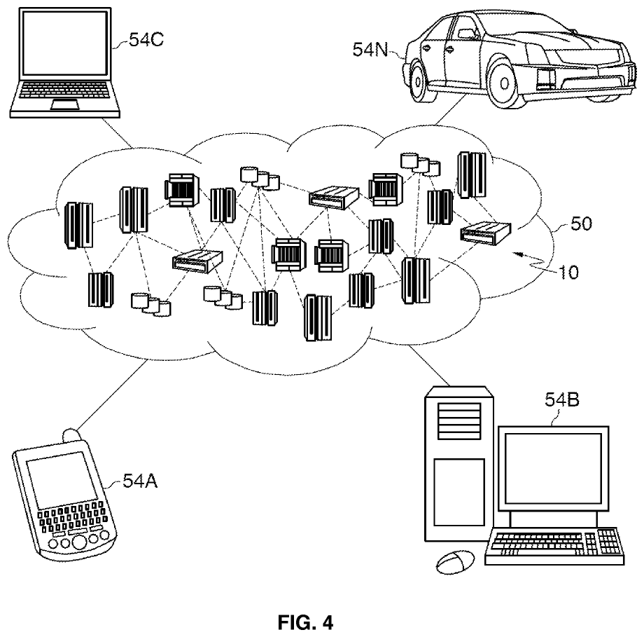

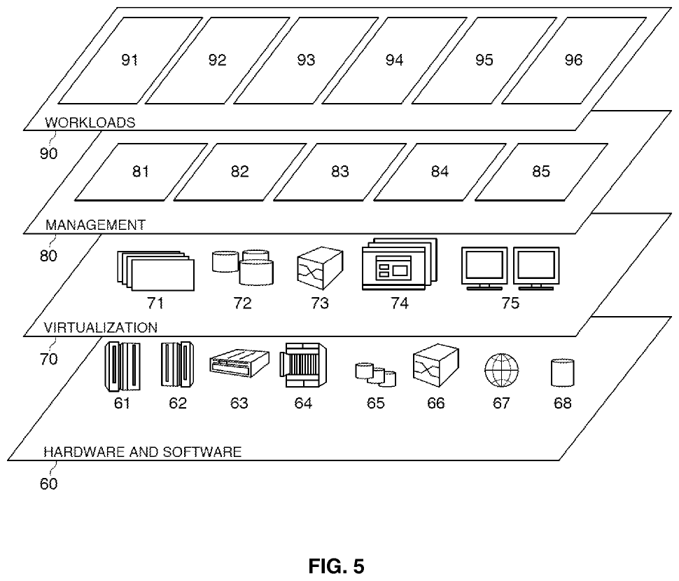

In the example embodiment, the smart device 120 includes a pollination prediction client 122, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. While the smart device 120 is shown as a single device, in other embodiments, the smart device 120 may be comprised of a cluster or plurality of computing devices, in a modular manner, etc., working together or working independently. The smart device 120 is described in greater detail as a hardware implementation with reference to FIG. 3, as part of a cloud implementation with reference to FIG. 4, and/or as utilizing functional abstraction layers for processing with reference to FIG. 5.

The pollination prediction client 122 may act as a client in a client-server relationship with a server, for example a pollination prediction server 130. The pollination prediction client 122 may also be a software and/or hardware application capable of communicating with and providing a user interface for a user to interact with a server via the network 108. Moreover, in the example embodiment, the pollination prediction client 122 may be capable of transferring data from the sensors 110 between the smart device 120, pollination prediction server 130, and other devices via the network 108. In embodiments, the pollination prediction client 122 utilizes various wired and wireless connection protocols for data transmission and exchange, including Bluetooth, 2.4 gHz and 5 gHz internet, near-field communication, Z-Wave, Zigbee, etc. The pollination prediction client 122 is described in greater detail with respect to FIG. 2.

In the exemplary embodiments, the pollination prediction server 130 may include one or more pollination prediction models 132 and a pollination predictor 134, and may act as a server in a client-server relationship with the pollination prediction client 122. The pollination prediction server 130 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the pollination prediction server 130 is shown as a single device, in other embodiments, the pollination prediction server 130 may be comprised of a cluster or plurality of computing devices, working together or working independently. The pollination prediction server 130 is described in greater detail as a hardware implementation with reference to FIG. 3, as part of a cloud implementation with reference to FIG. 4, and/or as utilizing functional abstraction layers for processing with reference to FIG. 5.

The pollination prediction models 132 may be one or more algorithms modelling a correlation between one or more features detected by the sensors 110 and a current pollination state or future pollination state. In the example embodiment, the pollination prediction models 132 may be generated using machine learning methods, such as neural networks, deep learning, hierarchical learning, Gaussian Mixture modelling, Hidden Markov modelling, and K-Means, K-Medoids, or Fuzzy C-Means learning, etc., and may model a likelihood of one or more features being indicative of a current pollination state or future pollination state. In embodiments, such features may include pollination event (e.g. a bee pollinating a flower) features such as plant types, insect types, insect sizes, durations of pollination events, etc. The extracted features may further include pollination prediction features such as plant types, numbers of hives, types of hives, locations of hives, weather, seasons, durations until successful pollination, etc. The pollination prediction models 132 may weight the features based on an effect that the features have on making pollination evaluations and predictions.

In the exemplary embodiments, the pollination predictor 134 may be a software and/or hardware program capable of collecting training data, extracting features from the training data, and training one or more models based on the extracted features. The pollination predictor 134 may additionally be capable of configuring a session and collecting data, extracting features from the collected data, and applying one or more models to the extracted features to determine a current pollination state and predict a future pollination state. Moreover, the pollination predictor 134 may be further configured for notifying the user of the current pollination state and predicted future pollination state. The pollination predictor 134 is additionally capable of evaluating whether the current pollination state and future pollination state were determined appropriately and adjusting the one or more models. The pollination predictor 134 is described in greater detail with reference to FIG. 2.

FIG. 2 depicts an exemplary flowchart illustrating the operations of a pollination predictor 134 of the pollination prediction system 100 in making pollination evaluations and predictions, in accordance with the exemplary embodiments. In exemplary embodiments, the pollination predictor 134 first implements a training phase in which it trains the pollination prediction models 132 using training data including labelled data of various pollination events or occurrences. In embodiments, the pollination predictor 134 may utilize the trained pollination prediction models 132 to make one or more pollination evaluations and predictions. The pollination predictor 134 then moves on to an operational phase in which it applies the trained pollination prediction models 132 to current pollination data to evaluate a current state of pollination and predict one or more future states of pollination.

The pollination predictor 134 may collect and/or receive training data (step 204). In embodiments, training data may include footage of one or more pollination events (e.g. a bee pollinating a flower) labelled with one or more timestamps and/or one or more locations of the one or more pollination events. The pollination predictor 134 may retrieve training data via user upload/input, databases, or the sensors 110. In embodiments, the pollination predictor 134 may collect training data via the sensors 110 as footage from one or more video cameras pointed towards one or more flowers and/or one or more hives, data from a global positioning services (GPS) sensor attached to or located near a video camera, flower, hive, landmark, etc. For example, training data may be collected as footage of one or more pollination events taking place near a video camera labelled with timestamps of the one or more pollination events and locations (flower location identification and/or plant location identification) of the one or more pollination events.

In embodiments, the pollination predictor 134 may additionally collect and/or receive training data as data of successful pollination practices (step 204 continued). In embodiments, data of successful pollination practices may include time durations that one or more users (e.g. farmers) waited for their crops or orchards to be fully pollinated by a given number of hives. Data of successful pollination practices may additionally include the placement locations of one or more hives, data of one or more hives (number of bees per hive, maturity of bees, etc.), weather during pollination, season during pollination, etc. Data of successful pollination practices may be indicative of how long a farmer may expect to wait for an orchard to be completely pollinated, when a farmer should move a location of one or more hives for optimal pollination, where a farmer should place one or more hives for optimal pollination, etc. The pollination predictor 134 may utilize training data such as data of successful pollination practices in order to train one or more pollination prediction models 132 to make one or more future pollination predictions based on a current pollination evaluation.

In embodiments, collected training data may also be associated to one or more types of flowers, plants, orchards, hives, etc. (step 204 continued). For example, footage of dandelions being pollinated by honeybees may be labelled with “dandelions” and “honeybees,” while footage of roses being pollinated by honeybees may be labelled with “roses” and “honeybees.” The pollination predictor 134 may collect training data associated with specific types of flowers, plants, orchards, hives, etc. to later train different pollination prediction models 132 for different types of flowers, plants, orchards, hives, etc. based on the user preferences. In embodiments, the pollination predictor 134 may collect training data to train one pollination prediction model 132 to make one or more pollination evaluation and/or prediction for all types of flowers, plants, orchards, hives, etc.

To further illustrate the operations of the pollination predictor 134, reference is now made to an illustrative example where the pollination predictor 134 collects training data consisting of video footage of pollination events labelled with timestamps and locations of pollination events. The pollination predictor 134 additionally collects training data consisting of time durations that one or more farmers waited for their crops to be fully pollinated by a given number of hives, the placement locations of those hives, and the number of bees in those hives.

The pollination predictor 134 may extract one or more features from the collected and/or received training data (step 206). The extracted features may be extracted from the collected training data, which may include data collected via user upload/input, databases, or the sensors 110, etc. of one or more pollination events and/or successful pollination practices. The extracted features may include pollination event features such as plant types, insect types, insect sizes, durations of pollination events, etc. The extracted features may further include pollination prediction features such as plant types, numbers of hives, types of hives, locations of hives, weather, seasons, durations until successful pollination, etc. In embodiments, the pollination predictor 134 may use techniques such as feature extraction, natural language processing, optical character recognition, image processing, video processing, timestamp analysis, pattern/template matching, data comparison, etc. to identify pollination event features such as plant types, insect types, insect sizes, durations of pollination events, etc. For example, the pollination predictor 134 may extract plant types and insect types directly from one or more databases via optical character recognition and insect sizes and durations of pollination events directly from one or more sensors 110 via image processing, video processing, etc. In embodiments, durations of pollination events may be extracted as the difference in time between a bee landing on a flower and a bee leaving a flower, wherein the difference is above a threshold (i.e., minimum time threshold to define “pollination” as taking place). This threshold may be determined when training one or more pollination prediction models 132. In embodiments, the pollination predictor 134 may extract pollination event features such as plant types, insect types, insect sizes, and durations of pollination events.

In addition to extracting pollination event features such as plant types, insect types, insect sizes, and durations of pollination events, the pollination predictor 134 may also extract pollination prediction features such as plant types, numbers of hives, types of hives, locations of hives, weather, seasons, durations until successful pollination, etc. (step 206 continued). In embodiments, the pollination predictor 134 may use techniques such as feature extraction, natural language processing, optical character recognition, image/video processing, timestamp analysis, pattern/template matching, data comparison, convolutional neural networks, etc. to identify pollination prediction features such as plant types, numbers of hives, types of hives, locations of hives, weather, seasons, durations until successful pollination, etc. For example, the pollination predictor 134 may extract plant types, numbers of hives, and types of hives directly from one or more databases or user upload/input via optical character recognition, locations of hives directly from GPS data of the sensors 110, weather and seasons from one or more internet searches via network 108, etc. The pollination predictor 134 may additionally extract durations until successful pollination by identifying an average pollination event rate (i.e., number of pollination events over a period of time) and an associated duration until crops are successfully or adequately pollinated. The pollination predictor 134 may later associate extracted features with one or more pollination evaluations and/or predictions when training one or more models.

With reference to the previously introduced example where the pollination predictor 134 collects training data consisting of video footage of pollination events labelled with timestamps of pollination events, time durations that one or more farmers waited for their orchards to be fully pollinated by a given number of hives, the placement locations of those hives, and the number of bees in those hives, the pollination predictor 134 extracts pollination event features such as plant types, insect types, insect sizes, and durations of pollination events, as well as pollination prediction features such as plant types, numbers of hives, types of hives, locations of hives, weather, seasons, durations until successful pollination, etc. from the collected training data.

The pollination predictor 134 may train one or more pollination prediction models 132 based on the extracted features (step 208). The pollination predictor 134 may train one or more pollination prediction models 132 based on an association of the one or more extracted features with one or more pollination evaluations and/or predictions. As previously mentioned, such extracted features may include pollination event features such as plant types, insect types, insect sizes, durations of pollination events, etc. as well as pollination prediction features such as plant types, numbers of hives, types of hives, locations of hives, weather, seasons, durations until successful pollination, etc., and the one or more pollination prediction models 132 may be generated through machine learning techniques such as convolutional neural networks. As previously discussed, the pollination predictor 134 may train one or more pollination prediction models 132 by determining a minimum pollination event time threshold and/or an average number of pollination events over a given time. Moreover, the pollination predictor 134 may train the one or more pollination prediction models 132 to weight the features such that features shown to have a greater correlation with an accurate pollination evaluation and/or prediction are weighted greater than those features that are not. In embodiments, pollination evaluations may include one or more graphs, tables, charts, maps, etc. depicting which areas of crops, flowers, etc. of an orchard, farm, etc. have been pollinated sufficiently and which have not been pollinated sufficiently. In embodiments, pollination predictions may include one or more predictions, suggestions, pieces of advice, etc. to a user detailing how much longer the user should wait for adequate pollination to be completed, when to move the location of one or more hives, where to move one or more hives, etc. Moreover, as previously mentioned, the pollination predictor 134 may train different pollination prediction models 132 for different types of flowers, plants, orchards, hives, etc. Based on the pollination prediction models 132's extracted features and weights associated with such extracted features, the pollination predictor 134 may later determine one or more pollination evaluations and/or predictions.

With reference to the previously introduced example where the pollination predictor 134 extracts pollination event features such as plant types, insect types, insect sizes, and durations of pollination events, as well as pollination prediction features such as plant types, numbers of hives, types of hives, locations of hives, weather, seasons, durations until successful pollination, etc. from the collected training data, the pollination predictor 134 trains a model based on an association of the extracted features with one or more pollination evaluations and predictions.

The pollination predictor 134 may receive a configuration (step 210). The pollination predictor 134 may receive a configuration by receiving a user registration and user preferences. The user registration may be uploaded by a user, i.e., a person using or overseeing the pollination prediction system 100 (farmer, pollination specialist) etc. and the configuration may be received by the pollination predictor 134 via the pollination prediction client 122 and the network 108. Receiving the user registration may involve referencing a user profile via user login credentials, internet protocol (IP) address, media access control (MAC) address, etc., or receiving user input information such as a name, date of birth, address/geographic information, phone number, email address, company name, device serial number, smart device 120 type, types of the sensors 110, and the like. Lastly, the pollination predictor 134 may receive a configuration of the one or more sensors 110, which may be fixed within an environment in which the pollination prediction system 100 is implemented.

During configuration, the pollination predictor 134 may further receive user preferences (step 210 continued). User preferences may include preferences for the manner in which the pollination predictor 134 should notify one or more users of a pollination evaluation and/or prediction. For example, a user may upload user preferences specifying that they are to be notified of a pollination evaluation in the form of a map of their crops color coded by pollination level. In another example, a user may upload user preferences specifying that they are to be audially notified of pollination predictions detailing how long the user should anticipate waiting for sufficient pollination to be complete as well as when and where to move one or more hives for sufficient pollination.

With reference to the previously introduced example where the pollination predictor 134 trains a model based on an association of the extracted features with one or more pollination evaluations and predictions, the user uploads a user registration including the user's name, user's smartphone as smart device 120, and user's video cameras as sensors 110. The user also uploads user preferences specifying that they are to be notified of a pollination evaluation visually via the screen of their smart device 120 in the form of a map of their crops color coded by pollination level. The user preferences also specify that the user is to be notified of pollination predictions audially via integrated speakers of their smart device 120 detailing how long the user should anticipate waiting for sufficient pollination to be complete as well as when and where to move one or more hives for sufficient pollination.

The pollination predictor 134 may collect and/or receive data (step 212). In embodiments, collected and/or received data may include footage of one or more pollination events. The pollination predictor 134 may retrieve data via user upload/input, databases, or the sensors 110. In embodiments, the pollination predictor 134 may collect data via the sensors 110 as footage from one or more video cameras pointed towards one or more flowers and/or one or more hives, data from a global positioning services (GPS) sensor attached to or located near a video camera, flower, hive, landmark, etc.

With reference to the previously introduced example where the user uploads a user registration and user preferences, the pollination predictor 134 collects video footage of pollination events from the registered video cameras (sensors 110).

The pollination predictor 134 may extract one or more features from the collected data (step 214). The pollination predictor 134 may extract one or more features from the collected data in the same manner as described above with respect to extracting features from the training data. However, the pollination predictor 134 extracts one or more features from the current collected data instead of from the previously collected training data.

With reference to the previously introduced example where the pollination predictor 134 collects video footage of pollination events from the registered video cameras, the pollination predictor 134 extracts plant types pumpkins, squash, and cucumbers, insect types honeybees, bumblebees, and squash bees, insect sizes medium and large, number of hives: 30 (10 of each bee type), season: summer. The pollination predictor 134 additionally extracts the locations of each hive, the locations and time durations of each pollination event captured by the video footage, and the weather during the video footage (rain on days 2, 5, and 6).

The pollination predictor 134 may apply one or more models to the extracted features to evaluate and predict pollination states (step 216). As previously mentioned, such extracted features may include pollination evaluation features such as plant types, insect types, insect sizes, durations of pollination events, etc. as well as pollination prediction features such as plant types, numbers of hives, types of hives, locations of hives, weather, seasons, durations until successful pollination, etc., and the one or more pollination prediction models 132 may be generated through machine learning techniques such as neural networks. In embodiments, the one or more pollination prediction models 132 may be trained at initialization and/or through the use of a feedback loop to weight the features such that features shown to have a greater correlation with determining an accurate pollination evaluation or prediction are weighted greater than those features that are not. Based on the extracted features and weights associated with such extracted features, the pollination predictor 134 may determine a pollination evaluation and/or prediction. As previously mentioned, pollination evaluations may include one or more graphs, tables, charts, maps, etc. depicting which areas of an orchard, farm, etc. have been pollinated sufficiently and which have not been pollinated sufficiently. In embodiments, pollination predictions may include one or more predictions, suggestions, pieces of advice, etc. to a user detailing how much longer the user should wait for adequate pollination to be completed, when to move the location of one or more hives, where to move one or more hives, etc. In embodiments where multiple pollination prediction models 132 are trained for various types of flowers, plants, orchards, hives, etc., the pollination predictor 134 may apply one or more pollination prediction models 132 specific to the one or more types of flowers, plants, orchards, hives, etc. extracted above.

With reference to the previously introduced example where the pollination predictor 134 extracts features from the collected data, the pollination predictor 134 applies the previously trained model to determine that the majority of the user's crops are sufficiently pollinated, but one region of crops containing squash is only 50% pollinated while another region of crops containing cucumbers is only 25% pollinated. The pollination predictor 134 additionally applies the previously trained model to predict that the user should relocate three beehives from sufficiently pollinated regions to the region that is 50% pollinated and six beehives from sufficiently pollinated regions to the region that is 25% pollinated. The pollination predictor 134 applies the previously trained model to determine that the user should anticipate waiting one more day after relocating beehives for the entirety of their crops to be sufficiently pollinated.

Upon the pollination predictor 134 determining one or more pollination evaluations and/or predictions, the pollination predictor 134 may notify the user of the pollination evaluations and/or predictions (step 218). The pollination predictor 134 may notify the user and/or others in the form of audio, video, text, or any other manner via the smart device 120 or any other device. The notification may be conveyed visually via text and/or audially via one or more integrated speakers. For example, one or more graphs, tables, charts, maps, etc. depicting which areas of an orchard, farm, etc. have been pollinated sufficiently and which have not been pollinated sufficiently may be communicated to a user visually on one or more screens of the user's smart device 120. In embodiments, pollination predictions such as how much longer the user should wait for adequate pollination to be completed, when to move the location of one or more hives, where to move one or more hives, etc. may be communicated to a user audially via one or more integrated speakers of the user's smart device 120. In embodiments, the pollination predictor 134 may notify one or more other users or administrators such as the user's employees, co-workers, etc. As previously discussed, the pollination predictor 134 may notify the user and/or others of one or more pollination evaluations and/or predictions according to the user preferences of configuration.

With reference to the previously introduced example where the pollination predictor 134 determines pollination evaluations and predictions, the pollination predictor 134 visually notifies the user with a map depicting the regions of crops that are sufficiently pollinated, 50% pollinated, and 25% pollinated, and additionally audially notifies the user that they should relocate three beehives from sufficiently pollinated regions to the region that is 50% pollinated and six beehives from sufficiently pollinated regions to the region that is 25% pollinated, and that the user should anticipate waiting one more day after relocating beehives for the entirety of their crops to be sufficiently pollinated on the user's smart device 120 according to the user's preferences.

The pollination predictor 134 may evaluate and modify the pollination prediction models 132 (step 220). In the example embodiment, the pollination predictor 134 may verify whether the one or more pollination evaluations and/or predictions were accurate in order to provide a feedback loop for modifying the pollination prediction models 132. In embodiments, the feedback loop may simply provide a means for a user to indicate whether the one or more pollination evaluations and/or predictions were accurate, helpful, useful, etc. The feedback loop indication may be triggered via a toggle switch, button, slider, etc. that may be selected by the user manually by hand using a button/touchscreen/etc., by voice, by eye movement, and the like. Based on the pollination predictor 134 accurately or inaccurately determining one or more pollination evaluations and/or predictions, the pollination predictor 134 may modify the pollination prediction models 132 relating to determination of pollination evaluations and/or predictions. In other embodiments, the pollination predictor 134 may infer or deduce whether the determined evaluation and/or prediction were correct. For example, if the pollination predictor 134 evaluates a region of crops as having completed pollination but bees continue to pollinate that region of crops, the pollination predictor 134 may determine that its evaluation was inaccurate and modify the pollination prediction models 132 accordingly. In another example, if the pollination predictor 134 predicts that a user will have to wait two days for their crops to complete pollination, but the user submits feedback that their crops were not sufficiently pollinated after two days, the pollination predictor 134 may infer that the prediction was inaccurate and modify the pollination prediction models 132 accordingly. In a third example, if a user proceeds to relocate beehives in a manner other than suggested by the pollination predictor 134, the pollination predictor 134 may infer that one or more pollination evaluation and/or prediction was inaccurate and modify the pollination prediction models 132 accordingly. Based on feedback received in the above or any other manners, the pollination predictor 134 may then modify the pollination prediction models 132 to more accurately make pollination evaluations and predictions.

With reference to the previously introduced example where the pollination predictor 134 visually notifies the user with a map depicting the regions of crops that are sufficiently pollinated, 50% pollinated, and 25% pollinated, and additionally audially notifies the user that they should relocate three beehives from sufficiently pollinated regions to the region that is 50% pollinated and six beehives from sufficiently pollinated regions to the region that is 25% pollinated, and that the user should anticipate waiting one more day after relocating beehives for the entirety of their crops to be sufficiently pollinated on the user's smart device 120 according to the user's preferences, the user submits feedback by hand using a touchscreen that the evaluation and predictions appear accurate and were helpful. The pollination predictor 134 modifies the pollination prediction models 132 accordingly.

FIG. 3 depicts a block diagram of devices within the pollination prediction system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a RAY drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, RAY drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and pollination evaluation and prediction 96.

The exemplary embodiments may be a system, a method, and/or a computer program product at any possible technical detail level of integration. The computer program product may include a computer readable storage medium (or media) having computer readable program instructions thereon for causing a processor to carry out aspects of the exemplary embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the exemplary embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the exemplary embodiments.

Aspects of the exemplary embodiments are described herein with reference to flowchart illustrations and/or block diagrams of methods, apparatus (systems), and computer program products according to the exemplary embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various exemplary embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for evaluating the pollination of one or more crops, the method comprising:
collecting pollination data;
extracting one or more features from the collected data; and
evaluating a current state of pollination of the one or more crops based on the extracted one or more features and one or more models.

2. The method of claim 1, further comprising:
notifying a user of the evaluation of the current state of pollination of the one or more crops in the form of one or more graphs, tables, charts, or maps.

3. The method of claim 1, further comprising:
predicting one or more of when to locate or relocate one or more hives, where to locate or relocate one or more hives, and how long to wait until sufficient pollination has been completed; and
notifying a user of the one or more predictions.

4. The method of claim 1, wherein the one or more models correlate the one or more features with the likelihood of accurately evaluating the current state of pollination and accurately predicting future pollination states.

5. The method of claim 1, further comprising:
receiving feedback indicative of whether the pollination evaluation was accurate; and
adjusting the one or more models based on the received feedback.

6. The method of claim 1, further comprising:
collecting training data;
extracting training features from the training data; and
training the one or more models based on the extracted training features.

7. The method of claim 1, wherein the one or more features include one or more features from the group comprising plant types, insect types, insect sizes, durations of pollination events, numbers of hives, types of hives, locations of hives, weather, seasons, and durations until successful pollination.

8. A computer program product for evaluating the pollination of one or more crops, the computer program product comprising:
one or more non-transitory computer-readable storage media and program instructions stored on the one or more non-transitory computer-readable storage media capable of performing a method, the method comprising:
collecting pollination data;
extracting one or more features from the collected data; and
evaluating a current state of pollination of the one or more crops based on the extracted one or more features and one or more models.

9. The computer program product of claim 8, further comprising:
notifying a user of the evaluation of the current state of pollination of the one or more crops in the form of one or more graphs, tables, charts, or maps.

10. The computer program product of claim 8, further comprising:
predicting one or more of when to locate or relocate one or more hives, where to locate or relocate one or more hives, and how long to wait until sufficient pollination has been completed; and
notifying a user of the one or more predictions.

11. The computer program product of claim 8, wherein the one or more models correlate the one or more features with the likelihood of accurately evaluating the current state of pollination and accurately predicting future pollination states.

12. The computer program product of claim 8, further comprising:
receiving feedback indicative of whether the pollination evaluation was accurate; and
adjusting the one or more models based on the received feedback.

13. The computer program product of claim 8, further comprising:
collecting training data;
extracting training features from the training data; and
training the one or more models based on the extracted training features.

14. The computer program product of claim 8, wherein the one or more features include one or more features from the group comprising plant types, insect types, insect sizes, durations of pollination events, numbers of hives, types of hives, locations of hives, weather, seasons, and durations until successful pollination.

15. A computer system for evaluating the pollination of one or more crops, the computer system comprising:
one or more computer processors, one or more computer-readable storage media, and program instructions stored on the one or more of the computer-readable storage media for execution by at least one of the one or more processors capable of performing a method, the method comprising:
collecting pollination data;
extracting one or more features from the collected data; and
evaluating a current state of pollination of the one or more crops based on the extracted one or more features and one or more models.

16. The computer system of claim 15, further comprising:
notifying a user of the evaluation of the current state of pollination of the one or more crops in the form of one or more graphs, tables, charts, or maps.

17. The computer system of claim 15, further comprising:
predicting one or more of when to locate or relocate one or more hives, where to locate or relocate one or more hives, and how long to wait until sufficient pollination has been completed; and
notifying a user of the one or more predictions.

18. The computer system of claim 15, wherein the one or more models correlate the one or more features with the likelihood of accurately evaluating the current state of pollination and accurately predicting future pollination states.

19. The computer system of claim 15, further comprising:
receiving feedback indicative of whether the pollination evaluation was accurate; and
adjusting the one or more models based on the received feedback.

20. The computer system of claim 15, further comprising:
collecting training data;
extracting training features from the training data; and
training the one or more models based on the extracted training features.
